(19) United States
(12) Patent Application Publication
(10) Pub. No.: US 2005/0235015 A1
(43) Pub. Date: Oct. 20, 2005

(54) User-configurable device storage synchronization manager

(75) Inventors: Thamer A. Abanami, Seattle, WA (US); W. Michael Anderson, Woodinville, WA (US); Andrew L. Silverman, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation

(21) Appl. No.: 10/816,789

(22) Filed: Mar. 31, 2004

(51) Int. Cl. G06F 12/00

(52) U.S. Cl. 707/204

(57) ABSTRACT

Described herein is a technology for facilitating a user-configurable model for managing synchronization, transfer, or copying of one or more subsets of a collection of digital data items between source and target computing systems.

### TECHNICAL FIELD

This invention generally relates to a technology for user-configurable device storage synchronization management.

### BACKGROUND

Due to the advance of digital media technology and decreasing price of storage, users increasingly host digital media collections on their main personal computers. Examples of digital media in such collections include music, pictures, videos, and the like.

However, not all consumption of digital media occurs on a user's main personal computer. More and more, users are in need of transferring all or some of their collection to portable client devices. Examples of a portable client device include Personal Media Players, Personal Digital Assistants (PDAs), and laptops. This way the consumer may enjoy their media away from their main personal computer.

With the advent of high capacity storage on portable client devices, filling these devices with a meaningful subset of a user's digital media collection can be a laborious task. This is especially true when the user's digital media collection is larger than the storage on the device (e.g. 100 GB digital media collection on main computer and 5 GB storage on client device).

Conventionally, the user is left to manually manage this problem. If the collection of digital media on the source device (e.g., main personal computer) exceeds the storage capacity of the target device (e.g., portable client device), the user manually selects which items to include (and/or exclude) in a transfer to the target.

Furthermore, in conventional approaches, the user must remove items from an otherwise full memory of the target device when the user wishes to replace it with a new item from the collection on the source device.

### SUMMARY

Described herein is a technology for facilitating a user-configurable model for managing synchronization, transfer, or copying of one or more subsets of a collection of digital data items between source and target computing systems.

### BRIEF DESCRIPTION OF THE DRAWINGS

The same numbers are used throughout the drawings to reference like elements and features.

FIG. 1 is a graphic illustration of a typical source and target scenario in accordance with an implementation described herein.

FIG. 2 illustrates an example of a user-interface in accordance with an implementation described herein.

FIG. 3 illustrates another example of a user-interface in accordance with an implementation described herein.

FIG. 4 is a flow diagram showing an illustrative methodological implementation described herein.

### DETAILED DESCRIPTION

The following description sets forth techniques that facilitate a user-configurable model for managing synchronization of subsets of digital data collection between source and target computing systems. The techniques may be implemented in many ways, including (but not limited to) program modules, computing systems, dedicated electronics (such as portable multimedia devices), and as part of computer networks.

An exemplary implementation of these techniques may be referred to as an “exemplary target device storage sync manager” and is described below.

Exemplary User-Configurable Target Device Storage Sync Manager

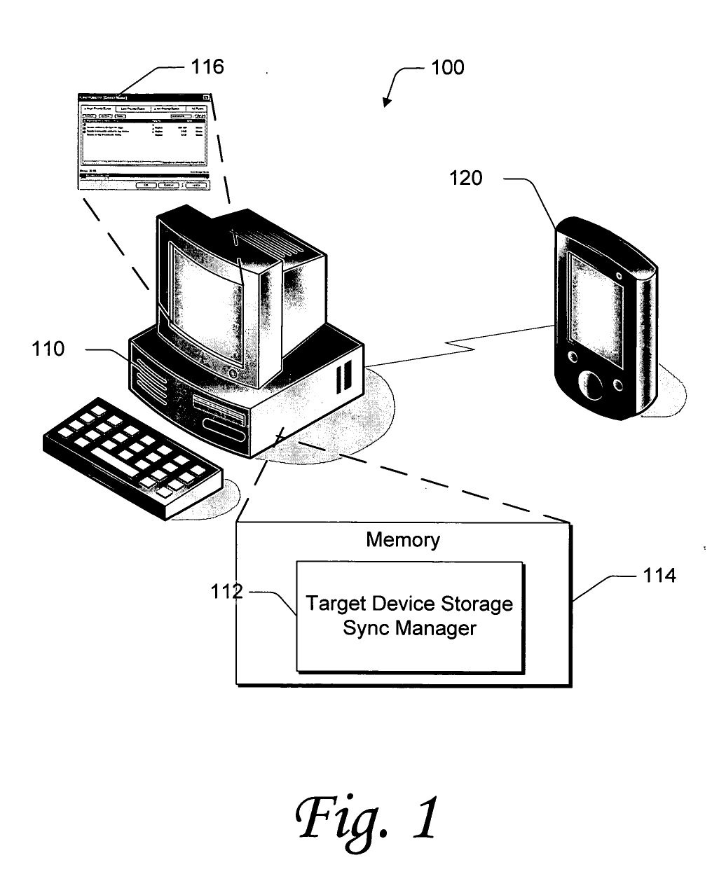

FIG. 1 illustrates a source-target synchronization scenario 100. The depicted scenario includes a source device 110 (e.g., a desktop personal computer) and a coupled target device 120 (e.g., a portable media player). The exemplary target device storage sync manager may be implemented on the source device 110.

For example, it may be implemented as a target device storage sync manager program module 112 embodied on one or more processor-readable media (such as a computer storage or memory 114). The program module 112 may operate on the source device 110. For example, it may be implemented as part of multimedia software product, an operating system, or a dedicated multimedia appliance.

The exemplary target device storage sync manager provides a user-configurable model for facilitating automatic transfer of a subset of a user's digital collection to the target device 120 from the source device 110. Some items in the digital collection may be more important to the user than others. Examples of digital items in a collection may include audio, video, text, or image files. It may also include static or automated playlist of files (e.g., audio, video, and images) or any grouping of files or data.

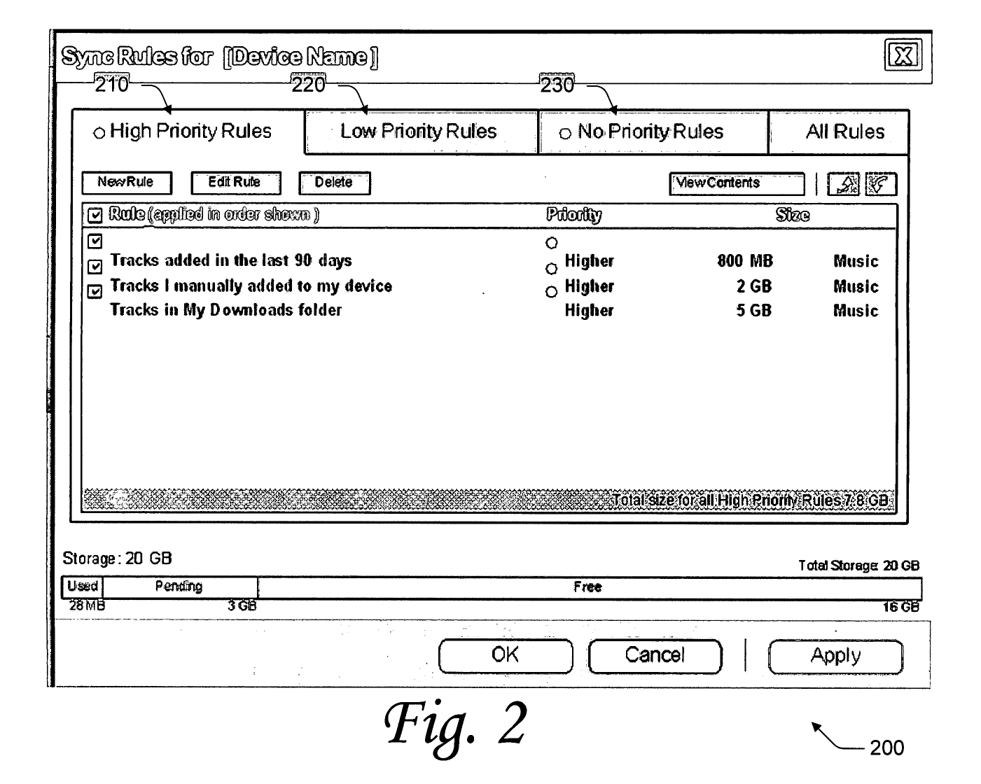

The exemplary target device storage sync manager explicitly, implicitly, and/or heuristically assigns digital items in the collection with a transfer priority to indicate their relative importance or desirability to the user. It does this, at least in part, via an easy-to-use user-interface (UI). An example of such a UI is shown at 116 in FIG. 1. This UI is a representation of the example UI 200 shown in FIG. 2.

The priority may be applied in one action to any grouping of media or data native to a host system or created by a user using the means provided by the host system.

In at least one embodiment, the digital items that matter most to the user are automatically transferred to the target device 120, the items that matter less may be used to dynamically fill the target device, and the items that user never wants on the device will not be transferred there.

The scenario 100 shows a transfer interface 130 between the source device 110 and target device 120. This physical interface may be wired or wireless. Examples of a wired interface include USB, IEEE 1394, IEEE1284 (“parallel” connection), RS-232 Serial connection, and/or Ethernet, Token Ring, and similar networks. Examples of a wireless interface include Bluetooth; Infra-Red (IR); 802.11a, b, or g; GPRS, CDMA, EVDO, EDGE, and other related wireless telephony data-transmission standards. In some implementations, this interface may provide for data transfer over a short distance (e.g., measured in a few feet) or over a long distance (e.g., measured in miles).

From the highest to lowest user-designated priority, items are automatically transferred from the source device 110 to the target device 120 via the interface 130. This transfer occurs until the collection is exhausted or the storage capacity of the target device is consumed. Assuming that the storage capacity of the target device 120 is less than that which would be consumed by the entire digital library, this action stores the most user-desirable digital items from the collection.

The transfer from the source device 110 to the target 120 (and vice versa) may be called “synchronization” (or simply “sync”). As the collection on the source device changes (e.g., items removed, items added, and/or item priority changes), the subset of the collection which is stored on the target device changes with each synchronization. Indeed, if storage space on the target device 120 is limited, items may be removed from the target device during synchronization and replaced with new items from the collection which have higher priority.

Typically, the synchronization process will remove the lowest priority items in bottom-up fashion until sufficient space is cleared to store higher priority items that have not yet been synced with the device.

Although the priority of the items is user-assignable, some embodiments may include pre-formed automatic settings (and/or heuristics) to anticipate a user's expected priority settings. For example, there may be a pre-formed setting to give a higher priority to all items new in the last week than to older items.

In FIG. 1, the source device 110 is depicted as a desktop personal computer. However, in other implementations, the source device may be a portable laptop computer, another portable device, a mini-computer, a mainframe computer, a server, a storage system, a dedicated digital appliance, or another device having a storage sub-system configured to store a collection of digital data items. Furthermore, the implemented source device 110 is configured to copy all or some of its collection of digital data items to a coupled device.

In FIG. 1, the target device 120 is depicted as a portable device, such as a media player. However, in other implementations, the target device may be a non-portable computer, a portable laptop computer, another portable device, a mini-computer, a mainframe computer, a server, a storage system, a dedicated digital appliance, or another device having a storage sub-system configured to store a collection of digital data items. Furthermore, the implemented target device 120 is configured to receive a copy of all or some of a coupled source device's collection of digital data items.

Herein, “digital items” of a digital collection is any type of independently addressable unit of digital data which is typically stored within a computer memory or storage system. Examples of such a “digital item” include (but are not limited to): music, image, video, text documents, hypertext document, documents of any format, applications, spreadsheets, graphics, playlists, and data. A digital item may include a collection of other items.

### Exemplary Embodiments

This section describes two or more examples of embodiments of the exemplary target device storage sync manager. Of course, these are just examples and other embodiments are within the scope of the appended claims.

One embodiment employs a priority model with two or more easily identifiable and explainable tiers of explicit transfer priority exposed to the user. Using a UI of this embodiment, the user explicitly assigns a digital item to one of the multiple priority tiers.

Exemplary Three Tier Model

For example, there may be three transfer priority tiers. These may be called, for example, “High,”, “Low,” or “None.” Alternatively, they may be called, for example, “Always transfer,”, “Transfer if there is space,” or “Never transfer.”

Upper Tier: With this three tier model, the exemplary target device storage sync manager will attempt to always automatically transfer the digital items assigned to the highest priority tier. If all of these items cannot be transferred to the target device, then user will be notified.

The user may, for example, assign an item to this tier by selecting it (e.g., clicking on it) and expressly selecting the highest priority. Alternatively, an item may be implicitly or heuristically selected based upon defined (or pre-defined) settings. For example, recently used items or items on a media playlist may have the highest priority.

Lower Tier: With this three tier model, the exemplary target device storage sync manager will attempt to automatically transfer items designated low priority to the target device only if there is storage space available on the target device after all of the higher tier items have been transferred.

By default, a user's entire digital library may be designated to be in this low priority tier. Alternatively, the user may expressly select items to be in this tier.

Never Tier: With this three tier model, the exemplary target device storage sync manager will never automatically transfer items designated “never” priority to the target device, even if it is part of another collection with a higher priority.

A user may, for example, assign an item to this tier by selecting it (e.g., clicking on it) and expressly selecting the never priority. Alternatively, an item may be implicitly or heuristically selected based upon defined (or pre-defined) settings. For example, items rated less than a defined level may be designated to be part of the never priority tier.

FIG. 2 shows an example of a user-interface (UI) 200 that employs this three tier model. As indicated by tab 210 of the UI, a list of rules used to designate digital items (specifically, music clips here) as being high priority is shown. In particular, the rules include “tracks added in the last 90 days,” “Tracks I manually added to my device,” and “tracks in my download folder.”

Not shown, but indicated by similar tabs, is a low priority rules tab 220 that contains lists of rules that define low priority digital items and a no priority rules tab 230 that contains lists of rules the define no priority digital items. Using this UI, the user may choose the tier for each digital item in the collection.

Exemplary Two Tier Model

Instead of three, there may be just two transfer priority tiers. These may be called, for example, “Will Fit,” or “Exclude.”

Will Fit Tier: With this two tier model, the exemplary target device storage sync manager will attempt to always automatically transfer the digital items assigned to this tier and transfer all that “will fit” into the available storage space in the target device.

If all of these items in this tier do not fit, then a conflict resolution strategy will be used. The exemplary target device storage sync manager may implement any desirable conflict resolution strategy. Examples of such strategies include sorts, recently added, recently accessed, frequency of access, ratings, random, etc.

A user may, for example, assign an item to this tier by selecting it (e.g., clicking on it) and expressly selecting the “will fit” priority. Alternatively, an item may be implicitly or heuristically selected based upon defined (or pre-defined) settings. For example, recently used items or items on a media playlist may have this priority.

Alternatively, a user's entire digital library may be designated to be in this priority tier by default.

Exclude Tier: With this two tier model, the exemplary target device storage sync manager will never automatically transfer items designated “exclude” priority to the target device, even if it is part of another collection with a higher priority.

A user may, for example, assign an item to this tier by selecting it (e.g., clicking on it) and expressly selecting the never priority. Alternatively, an item may be implicitly or heuristically selected based upon defined (or pre-defined) settings. For example, items rated less than a defined level may be designated to be part of the “exclude” priority tier.

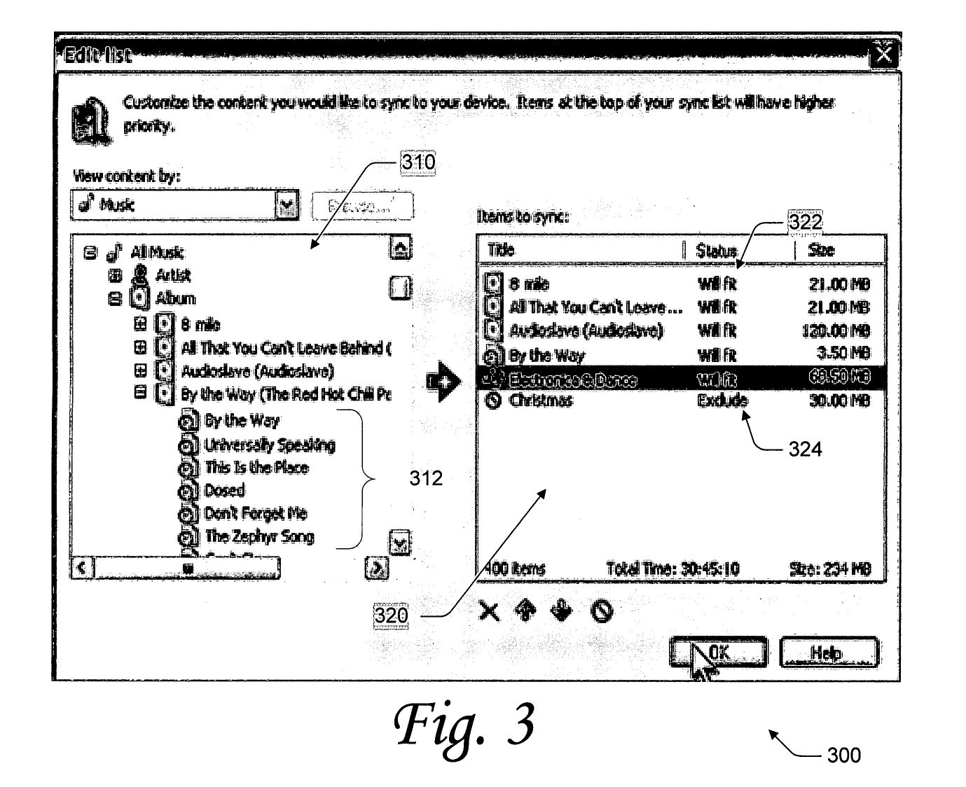

FIG. 3 shows an example of a user-interface (UI) 300 that employs this two tier model. In area 310 of the UI, there is a list of digital items (specifically, music clips here) such as those designated 312. Area 320 shows the assigned priority tier of some of the digital items. For example, “8 mile” is designated to be part of the will-fit tier 322 while “Christmas” is part of the excluded tier 324. Using this UI, the user may choose the tier for each digital item in the collection.

Methodological Implementation

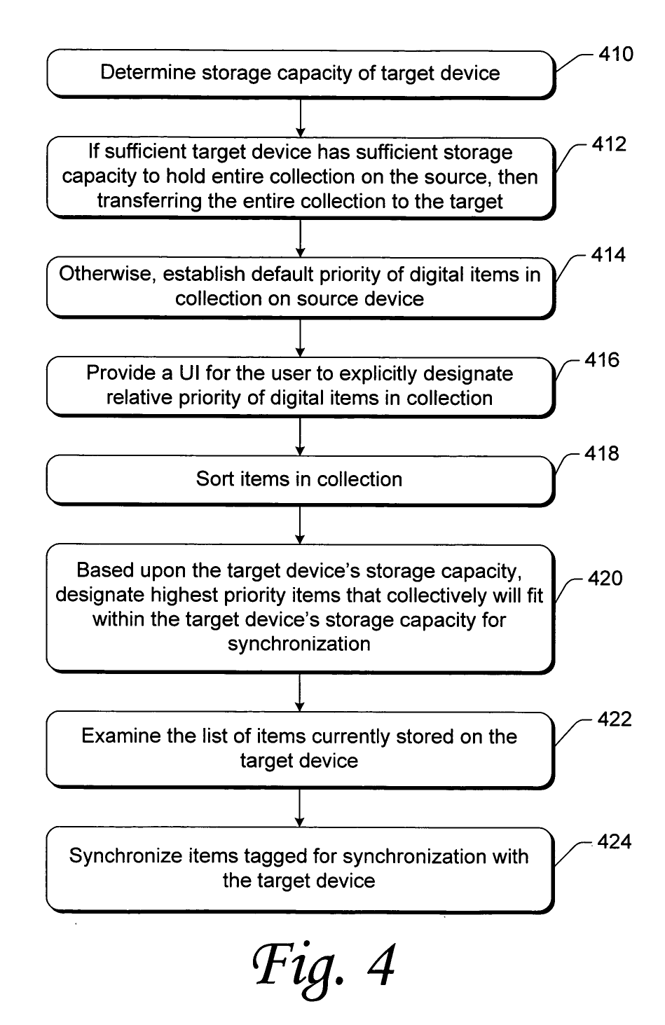

FIG. 4 shows a methodological implementation of the exemplary target device storage sync manager (e.g., such as that embodied by program module 112). This methodological implementation may be performed in software, hardware, or a combination thereof. For ease of understanding, the method steps are delineated as separate steps; however, these separately delineated steps should not be construed as necessarily order dependent in their performance.

At 410 of FIG. 4, the exemplary target device storage sync manager obtains an indication of the storage capacity of the target device 120. Typically, when a target device (like a personal multimedia player) is initially coupled to a source device, it will notify source about its storage capacity. For example, a multimedia player may inform a host desktop computer that it has a 40 GB storage capacity to store multimedia files.

At 412, if the storage requirement of the digital collection on the source device 110 is less than the storage capacity of the target device, then it automatically transfers the entire digital collection to the target device.

Otherwise, at 414, it implicitly or heuristically assigns a transfer priority digital items in a digital collection on the source device 110. That may be accomplished by rules to define a set of digital items to transfer. For example, tab 210 of the UI 200 of FIG. 2 shows a list of rules used to designate digital items (specifically, music clips here) as being high priority is shown. Therefore, the manager creates a set of items that have a priority level implicitly set.

At 416, the exemplary target device storage sync manager provides a user-interface (such as 200 or 300 of FIGS. 2 and 3) for the user to explicitly designate relative priority of digital items in the collection. Using such a UI, a user may manually order digital items to expressly designate their relative priority. For example, the user may employ a UI with a “stack” of digital items. Using this UI, the user may move items up or down within the stack.

At 418, based on the explicit, implicit, or heuristic priority assignments and/or based upon conflict resolutions strategies for items having otherwise equal priority, the exemplary target device storage sync manager sorts the items in the collection.

At 420, based upon the target device's storage capacity, it designates the highest priority items that collectively will fit within the device's storage capacity for synchronization. Items which are part of the “none,” “never” or “exclude” tier are automatically excluded from those tagged for synchronization.

At 422 of FIG. 4, the exemplary target device storage sync manager examines the list of items currently stored on the target device.

At 424, the exemplary target device storage sync manager synchronizes highest priority items that collectively will fit within the device's storage capacity. In doing so, it directs the target device to remove any digital item currently stored on the target device but is not tagged for synchronization. It also transfers to the target device any digital item tagged for synchronization, but not already stored on the target.

### CONCLUSION

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. One or more processor-readable media having processor-executable instructions that, when executed by a processor, performs acts comprising:
sorting a collection of digital items stored on a source device based, at least in part, upon a user-configurable priority assigned to the digital items in the collection;
designating a group of sorted digital items with highest priority for synchronization with a target device coupled to the source device;
synchronizing the designated group of digital items with the coupled target device.

2. One or more media as recited in claim 1 further comprising providing a user-interface which facilitates user-configurable assignment of priority for one or more digital items in the collection.

3. One or more media as recited in claim 1, wherein the storage requirements of the designated group of digital items is less than or equal to a defined storage capacity of the target device.

4. One or more media as recited in claim 1, wherein the storage requirements of the designated group of digital items is less than or equal to a defined storage capacity of the target device and the storage requirements of the collection of digital items is greater than the defined storage capacity of the target device.

5. One or more media as recited in claim 1, wherein the user-configurable priority assigned to a digital item is indicated as one of multiple priority tiers.

6. One or more media as recited in claim 1, wherein the synchronizing further comprises directing the target device to remove a digital item stored thereon but not part of the designated group of digital items for synchronization.

7. One or more media as recited in claim 1, wherein the synchronizing further comprises transferring from the source device a digital item which is part of the designated group of digital items for synchronization but not already stored on the target device.

8. One or more media as recited in claim 1, wherein digital items are audio, image, or video files.

9. One or more media as recited in claim 1, wherein digital items are selected from a group of digital content consisting of audio, image, video, text, hypertext, and data.

10. A computer comprising one or more processor-readable media as recited in claim 1.

11. A computing device comprising:
an audio/visual output;
a processor;
one or more processor-readable media as recited in claim 1.

12. One or more processor-readable media having processor-executable instructions that, when executed by a processor, produce a user-interface (UI), the UI comprising:
a first display area illustrating a listing of one or more digital items from a collection of digital items stored on a source device;
a second display area illustrating a user-configurable priority corresponding to the one or more digital items in the listing;
an executable process associated with the one or more digital items in the listing that is configured to:
designate a group of sorted digital items with highest priority for synchronization with a target device coupled to the source device, wherein the storage requirements of the designated group of digital items is less than or equal to a defined storage capacity of the target device;
synchronize the designated group of digital items with the coupled target device.

13. One or more media as recited in claim 12, wherein the storage requirements of the collection of digital items is greater than the defined storage capacity of the target device.

14. One or more media as recited in claim 12, wherein the user-configurable priority assigned to a digital item is indicated as one of multiple priority tiers.

15. One or more media as recited in claim 12, wherein the synchronization further comprises directing the target device to remove a digital item stored thereon but not part of the designated group of digital items for synchronization.

16. One or more media as recited in claim 12, wherein the synchronization further comprises transferring from the source device a digital item which is part of the designated group of digital items for synchronization but not already stored on the target device.

17. One or more media as recited in claim 12, wherein digital items are audio, image, or video files.

18. One or more media as recited in claim 12, wherein digital items are selected from a group of digital content consisting of audio, image, video, text, hypertext, and data.

19. A method comprising:
sorting a collection of digital items stored on a source device based, at least in part, upon a user-configurable priority assigned to the digital items in the collection;
designating a group of sorted digital items with highest priority for synchronization with a target device coupled to the source device, wherein the storage requirements of the designated group of digital items is less than or equal to a defined storage capacity of the target device;
synchronizing the designated group of digital items with the coupled target device.

20. A method as recited in claim 19 further comprising providing a user-interface facilitating user-configurable assignment of priority for one or more digital items in the collection.

21. A method as recited in claim 19, wherein the storage requirements of the collection of digital items is greater than the defined storage capacity of the target device.

22. A method as recited in claim 19, wherein the user-configurable priority assigned to a digital item is indicated as one of multiple priority tiers.

23. A method as recited in claim 19, wherein the synchronizing further comprises directing the target device to remove a digital item stored thereon but not part of the designated group of digital items for synchronization.

24. A method as recited in claim 19, wherein the synchronizing further comprises transferring from the source device a digital item which is part of the designated group of digital items for synchronization but not already stored on the target device.

25. A method as recited in claim 19, wherein digital items are audio, image, or video files.

26. A method as recited in claim 19, wherein digital items are selected from a group of digital content consisting of audio, image, video, text, hypertext, and data.

27. One or more processor-readable media having processor-executable instructions that, when executed by a processor, produce a user-interface (UI), the UI comprising:
a first display area illustrating a listing of one or more digital items from a collection of digital items stored on a source device;
a second display area illustrating a user-configurable priority corresponding to the one or more digital items in the listing.

28. One or more media as recited in claim 27, wherein the user-configurable priority assigned to a digital item is indicated as one of multiple priority tiers.

29. One or more media as recited in claim 27, wherein digital items are audio, image, or video files.

30. One or more media as recited in claim 27, wherein digital items are selected from a group of digital content consisting of audio, image, video, text, hypertext, and data.

31. A system comprising:
a sorting means for sorting a collection of digital items stored on a source device based, at least in part, upon a user-configurable priority assigned to the digital items in the collection;
a designating means for designating a group of sorted digital items with highest priority for synchronization with a target device coupled to the source device, wherein the storage requirements of the designated group of digital items is less than or equal to a defined storage capacity of the target device;
a synchronizing means for directing the target device to remove a digital item stored thereon but not part of the designated group of digital items for synchronization and for transferring from the source device a digital item which is part of the designated group of digital items for synchronization but not already stored on the target device.

32. A system as recited in claim 31 further comprising a providing means for providing a user-interface facilitating user-configurable assignment of priority for one or more digital items in the collection.

33. A system as recited in claim 31, wherein the storage requirements of the collection of digital items is greater than the defined storage capacity of the target device.

34. A system as recited in claim 31, wherein the user-configurable priority assigned to a digital item is indicated as one of multiple priority tiers.

35. A system as recited in claim 31, wherein digital items are audio, image, or video files.

36. A system as recited in claim 31, wherein digital items are selected from a group of digital content consisting of audio, image, video, text, hypertext, and data.
